(19) United States
(12) Patent Application Publication
(10) Pub. No.: US 2026/0342774 A1
(43) Pub. Date: Oct. 29, 2026

(54) ENCRYPTION PARAMETER NETWORK CONTROL

(71) Applicant: T-MOBILE INNOVATIONS LLC, Overland Park, KS (US)

(72) Inventor: A. Karl CORONA, Maple Valley, WA (US)

(21) Appl. No.: 19/191,339

(22) Filed: Apr. 28, 2025

(51) Int. Cl. H04L 9/40; H04L 65/1045; H04L 65/1073

(52) U.S. Cl. CPC H04L 63/0428; H04L 63/20; H04L 65/1045; H04L 65/1073

(57) ABSTRACT

Systems and methods are provided for controlling media plane encryption in a communication network. Initially, a registration request is received from a user device at a proxy call session control function (P-CSCF) node within an IP Multimedia Subsystem (IMS) network. The registration request includes user plane encryption parameters supported by the user device. At least one user plane encryption parameter that is supported by network policy and by the user device is determined, and the P-CSCF then responds to the user device with the at least one user plane encryption parameter that is supported by the network policy and by the user device.

### SUMMARY

The present disclosure is directed to controlling media plane encryption within an IP Multimedia Subsystem (IMS) network. Specifically, aspects address the interaction between a user device and the Proxy Call Session Control Function (P-CSCF) node during the registration process. While traditionally, the P-CSCF node responds to a registration request from a user device by sending back all supported user plane encryption parameters (e.g., encryption protocols), aspects provided herein provide for the P-CSCF node to selectively respond with only the user plane encryption parameters that align with the network's current policy. This selective response ensures that the user device adheres to the preferred encryption methods, thereby enhancing security and optimizing network performance.

The present disclosure addresses the challenges of the network side responding to the user device with all supported encryption methods, which leads to several issues, including a lack of network control. The user device essentially dictates the encryption method to be used, leaving the network operator with no control over the selection. This can result in the use of encryption methods that are not preferred or optimal for the network's security policy or capacity management. Further, when both the client device and the network support multiple encryption methods, there can be confusion during the negotiation process. The network might offer an encryption method that is not the primary preference of the client device, leading to negotiation problems and potential errors such as dropped calls.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates an exemplary network environment in which implementations of the present disclosure may be employed;

FIGS. 2A-2B illustrate communication diagrams for controlling media plane encryption in a communication network, according to aspects herein;

FIG. 3 depicts a flow diagram of an exemplary method for controlling media plane encryption in a communication network, according to aspects herein;

FIG. 4 depicts a flow diagram of an exemplary method for controlling media plane encryption in a communication network, according to aspects herein; and

FIG. 5 illustrates an exemplary computing device for use with the present disclosure.

### DETAILED DESCRIPTION

By way of background, current standards governing the negotiation of encryption methods between user devices and the IMS network are inadequate for ensuring network control. When a client device registers with the IMS network, it negotiates security parameters, including both control plane and user plane encryption methods. However, the standards require the network side to respond with all supported encryption methods, which leads to several issues. Initially, a key issue is a lack of network control. The user device essentially dictates the encryption method to be used, leaving the network operator with no control over the selection. This can result in the use of encryption methods that are not preferred or optimal for the network's security policy or capacity management. Further, when both the client device and the network support multiple encryption methods, there can be confusion during the negotiation process. The network might offer an encryption method that is not the primary preference of the client device, leading to negotiation problems and potential errors such as dropped calls.

Other reasons why the current standards governing the negotiation of encryption methods between user devices and the IMS network are inadequate for ensuring network control include the inability to control the encryption method, which can lead to inconsistent user experiences. For example, if the network offers an encryption method that the client device does not prefer, it can result in dropped calls or other communication failures, negatively impacting the user's experience. Even more, in scenarios involving text communications, the client device might offer encryption methods that the network operator does not support or want to use. This lack of control can lead to encrypted text being sent even when the network policy does not support it, further complicating the management of network resources and security.

Aspects described herein are directed to methods and systems for controlling media plane encryption within an IMS network. Specifically, aspects address the interaction between a user device and the P-CSCF node during the registration process. Traditionally, the P-CSCF node responds to a registration request from a user device by sending back all supported user plane encryption parameters. This approach can lead to inefficiencies and security vulnerabilities, as it does not allow the network to enforce preferred encryption protocols based on current network policies.

Aspects herein provide for the P-CSCF node to selectively respond with only the user plane encryption parameters that align with the network's current policy. This selective response ensures that the user device adheres to the preferred encryption methods, thereby enhancing security and optimizing network performance. Aspects also include provisions for dynamically updating the encryption parameters based on changes in network policy or user device capabilities, ensuring adaptability and robustness in varying network conditions.

As used herein, user plane encryption parameters are the encryption protocols used to secure the media plane, which includes audio, video, and text communications between the user device and the IMS network. Examples include SDES-SRTP, DTLS-SRTP, and MSRP-TLS. These parameters ensure that the data transmitted over the network is encrypted and protected from unauthorized access. P-CSCF is a component within the IMS network and acts as an intermediary between the user device and the IMS core network. It handles registration requests, session initiation, and other signaling functions. In the context of aspects herein, the P-CSCF node is responsible for determining and enforcing the preferred user plane encryption parameters.

Network policy, as used herein, refers to the set of rules and preferences defined by the network operator to manage and control various aspects of network operations, including security protocols, encryption methods, and resource allocation. Network policies are dynamic and can be updated based on changing network conditions, security requirements, and user device capabilities.

The proposed solution aims to address the issues describe above by introducing a method for controlling media plane encryption in the IMS network. For instance, the P-CSCF node within the IMS network may negotiate security parameters with the user device. Instead of responding with all supported encryption methods, the network may select a preferred encryption method based on a predefined network policy and respond with only that method. This ensures that the user device uses the selected encryption method for subsequent communications. By restricting the user device to use only the selected encryption method, the network operator gains control over the encryption process. This allows the operator to enforce network security policies and capacity management effectively, ensuring that the preferred encryption method is used consistently.

Further, aspects herein include the capability to update the encryption method selection dynamically based on changes in network policy or client device capabilities. This ensures continuous compliance with the preferred encryption method and allows the network to adapt to evolving security requirements and device capabilities. With the network controlling the encryption method, the likelihood of negotiation errors and dropped calls is significantly reduced. This leads to a more consistent and reliable user experience, as the user device will always use the preferred encryption method for media transmissions. The solution also addresses the issue of unwanted encryption in text communications. By controlling the encryption method selection, the network can ensure that only supported and desired encryption methods are used, preventing scenarios where encrypted text is sent against network policy.

Accordingly, a first aspect of the present disclosure is directed to a method for controlling media plane encryption in a communication network. The method comprises receiving a registration request from a user device at a P-CSCF node within an IMS network, where the registration request including user plane encryption parameters supported by the user device. Further, the method comprises determining at least one user plane encryption parameter that is supported by network policy and by the user device and responding to the user device with the at least one user plane encryption parameter that is supported by the network policy and by the user device.

Another aspect of the present disclosure is directed to a system for controlling media plane encryption in a communication network. The system comprises a P-CSCF node within an IMS network, where the P-CSCF node is configured to receive a registration request from a user device, where the registration request including one or more user plane encryption parameters supported by the user device. The P-CSCF is further configured to determine at least one user plane encryption parameter that is supported by network policy and respond to the user device with the at least one user plane encryption parameter that is supported by the network policy.

Another aspect of the present disclosure is directed to computer-readable media having instructions stored thereon that, when executed by one or more computer processing components, cause the one or more computer processing components to perform a method for dynamically updating media plane encryption parameters in a communication network. The method comprises monitoring changes in network policy and user device capabilities, determining if a current user plane encryption parameter is still supported by an updated network policy, and selecting a new user plane encryption parameter if the current user plane encryption parameter is no longer supported. Further, the method comprises upon receiving, from a user device, a registration request including user plane encryption parameters supported by the user device, communicating the new user plane encryption parameter to the user device.

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32nd Edition, 2022). As used herein, the terms “base station” or “access point” refer to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies suitable for use with the present disclosure include but are not limited to 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

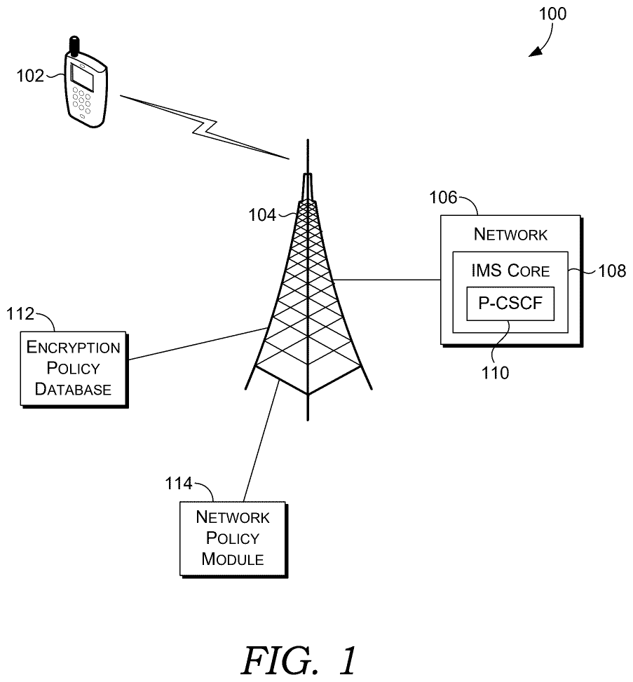

Turning now to FIG. 1, a network environment 100 is depicted, within which implementations of the present disclosure may be utilized. The network environment 100 comprises user device (UE) 102, cell site 104, telecommunication network 106, IMS Core 108, P-CSCF 110, and encryption policy database 112. The network environment 100 is illustrated as including singular instances of various components for clarity; however, multiple instances of each component are anticipated. For example, the network environment 200 may include multiple gateways, multiple satellites with or without inter-satellite links (ISLs), multiple terrestrial base stations, multiple UEs, and multiple distinct networks, any of which may be interconnected, federated, virtualized, or otherwise structured to provide seamless connectivity, mobility, and service continuity.

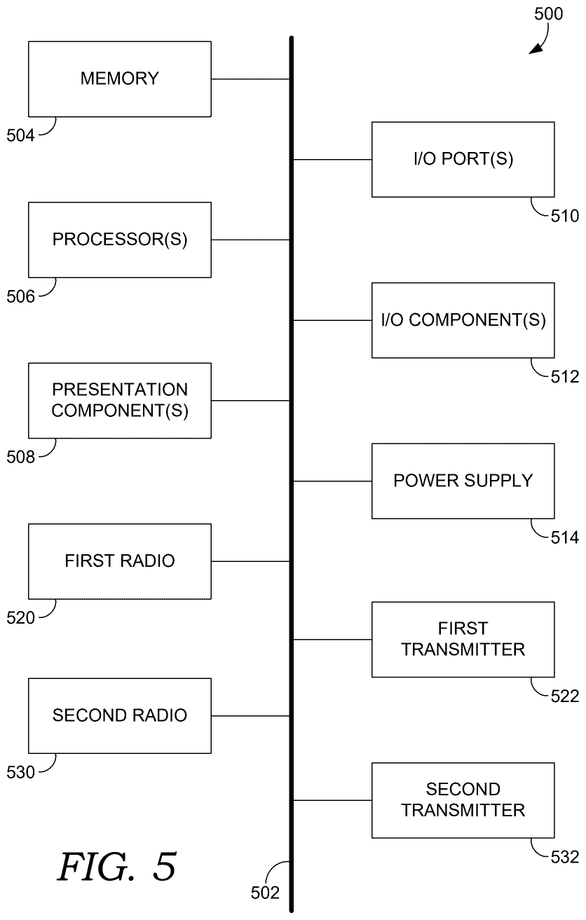

User device 102 may be any communication-capable device having one or more features, components, or characteristics of the computing device 500 of FIG. 5. In non-limiting examples, the user device 102 may be a tablet, laptop, desktop computer, connected consumer electronic device (e.g., smart TV), embedded module, IoT sensor, vehicle, aerial drone, smart wearable, industrial machine, or computing node in an edge computing framework. The user device 102 may support one or more wireless communication protocols, including 3GPP-based cellular access technologies (e.g., LTE, NR, 6G), unlicensed spectrum protocols (e.g., 802.11 Wi-Fi, Bluetooth, UWB, Zigbee, LoRaWAN), and/or satellite-specific protocols (e.g., DVB-S2, DVB-RCS2, CCSDS, proprietary waveforms). The user device 102 may be configured to operate in various mobility scenarios, including stationary, pedestrian, vehicular, airborne, or maritime mobility profiles, and may support adaptive transmission parameters such as beamforming, dynamic frequency selection, carrier aggregation, dual connectivity, multi-RAT coordination, and heterogeneous network (HetNet) offloading.

Telecommunications network 106 may comprise one or more interconnected networks and may include, individually or in combination, a cellular core network, an IMS network, or other packet-switched data networks, such as the Internet, enterprise networks, cloud infrastructures, content delivery networks (CDNs), broadband access networks operated by non-cellular Internet Service Providers (ISPs), or satellite core networks. In aspects wherein the network 106 takes the form of a cellular core network (e.g., a 4G LTE Evolved Packet Core (EPC), a 5G Core (5GC), or a future 6G core network), the network 106 may comprise one or more network functions, including but not limited to an Access and Mobility Management Function (AMF), Session Management Function (SMF), Short Message Service Function (SMSF), User Plane Function (UPF), Policy Control Function (PCF), Network Exposure Function (NEF), Unified Data Management (UDM), Unified Data Repository (UDR), Authentication Server Function (AUSF), Network Repository Function (NRF), Policy Control and Charging Function (PCF), Service Communication Proxy Function (SCPF), Session Management Function (SMF), Security Edge Protection Proxy (SEPP), Network Slice Selection Function (NSSF), Service Capability Exposure Function (SCEF), and one or more gateways (e.g., Packet Data Network Gateway (P-GW), Serving Gateway (SGW), User Plane Gateways, or similar nodes). The network 106 may facilitate capabilities such as mobility management, protocol translation, traffic tunneling, session management, network exposure, security enforcement, authentication, authorization, accounting, policy management, charging, and network slicing. Additionally, the network 208 may interconnect with multiple radio access networks (RANs), each associated with a unique or shared Public Land Mobile Network (PLMN) ID, Mobile Country Code (MCC), Mobile Network Code (MNC), or other identifiers relevant to cellular, satellite, private, hybrid, or non-cellular contexts.

Telecommunications network 106 may comprise a cell site 104. Although cell site 104 is illustrated as a macro cell tower for simplicity, it should be understood that cell site 104 may take numerous other forms, including but not limited to small cells, pico cells, femto cells, relay nodes, repeaters, remote radio heads (RRH), distributed antenna systems (DAS), cloud radio access network (C-RAN) nodes employing virtualized network functions (vRAN), and edge nodes operating at or near network edges. In residential, consumer-grade, or enterprise environments, cell site 104 may be implemented as a wireless access point (e.g., Wi-Fi access point/router, Wi-Fi mesh node, or wireless LAN controller), a private cellular base station (e.g., private LTE or private 5G small cell), or other networking equipment, such as an IoT gateway, Bluetooth beacon, Zigbee coordinator, LoRaWAN gateway, or ultra-wideband (UWB) anchor node.

Cell site 104 may communicate using any wireless telecommunication protocol desired by a network operator or network administrator, including but not limited to third-generation partnership project (3GPP) standards such as 3G (UMTS/WCDMA), 4G LTE, 5G New Radio (NR), future 6G standards, as well as IEEE 802.11x-based Wi-Fi protocols (e.g., Wi-Fi 4, Wi-Fi 5, Wi-Fi 6/6E, Wi-Fi 7 and later generations), Bluetooth, Bluetooth Low Energy (BLE), Zigbee, Thread, LoRa, NB-IoT, Z-Wave, and other proprietary or standardized short-range communication protocols designed for IoT connectivity.

Cell site 104 may further support advanced antenna technologies and resource allocation strategies, including multiple-input multiple-output (MIMO) antenna arrays (such as massive MIMO, MU-MIMO, full-duplex MIMO, or distributed MIMO configurations), analog, digital, or hybrid beamforming techniques, beam steering and beam management mechanisms, coordinated multipoint (CoMP) transmission/reception, carrier aggregation, dynamic spectrum sharing (DSS), non-orthogonal multiple access (NOMA), and radio resource management (RRM) algorithms. The RAN of cell site 104 may be configured using ultra-dense network (UDN) architectures or distributed systems that dynamically manage multiple individual beams to cover distinct or overlapping areas, adapting beam patterns in real-time based on user density, traffic demand, interference conditions, and UE mobility.

Telecommunication network 106 further comprises IMS Core 108, which comprises at least P-CSCF 110. IMS Core 108 is responsible for delivering multimedia services such as voice, video, and text over IP networks, such as telecommunication network 106. IMS Core 108 may comprise functional entities, including the Call Session Control Function (CSCF) nodes, Home Subscriber Server (HSS), Media Resource Function (MRF), and Application Servers (AS). The IMS core facilitates seamless integration and interoperability between different network types, ensuring efficient session management, authentication, and service delivery. By leveraging standardized protocols like SIP (Session Initiation Protocol), the IMS core provides a robust and scalable platform for deploying advanced communication services, enhancing user experience, and supporting the dynamic needs of both operators and subscribers.

P-CSCF 110 is responsible for, among other components, controlling media plane encryption within the IMS Core 108 and for managing the initial registration process of user devices and ensuring that the encryption protocols used for media transmissions adhere to the network's preferred policies. When a user device 102 sends a registration request to the IMS Core 108, the P-CSCF 110 receives this request, which includes the user plane encryption parameters supported by the device. The P-CSCF 110 then evaluates these parameters against the current network policy to determine which encryption protocols are preferred and supported by the network. This evaluation ensures that only the encryption methods that align with the network's security and operational preferences are selected.

In aspects, instead of responding with all the encryption parameters supported by the user device, the P-CSCF 110 selectively responds with only the preferred encryption parameters. This selective response mechanism is helpful for enforcing network policies and preventing the use of undesirable encryption methods. By controlling the encryption protocols at the network level, the P-CSCF 110 ensures that subsequent communications between the user device and the IMS network are secure and optimized. The P-CSCF 110 may also be equipped to dynamically update the user plane encryption parameters based on changes in network policy or user device capabilities. This dynamic updating process allows the network to adapt to evolving security requirements and technological advancements. Additionally, the P-CSCF 110 can negotiate encryption parameters during the registration process, ensuring that both the network and the user device agree on the preferred encryption methods.

Once the preferred encryption parameters are determined, the P-CSCF 110 may enforce these protocols for all media transmissions, including audio, video, and text communications. This enforcement ensures that the user device 102 adheres to the selected encryption methods, thereby maintaining the integrity and security of the communications within the IMS Core 108. The P-CSCF 110 may continuously monitor changes in network policy and user device capabilities to ensure that the current encryption parameters remain supported. If a change in network policy renders a current encryption parameter unsupported, the P-CSCF 110 selects a new preferred encryption parameter and communicates this to the user device 102. This ongoing monitoring and control process is essential for maintaining a secure and efficient network environment.

In aspects, network policy module 114 is responsible for consulting the encryption policy database 112 to determine the one or more encryption parameters supported or preferred by the network 106. As discussed, user device 102 communicates a registration request to P-CSCF 110, and the registration request includes the encryption protocols supported by user device 102. While traditionally P-CSCF 110 will send back all these encryption protocols to the user device 102 in its response, allowing the user device 102 to dictate the encryption protocol, aspects herein provide for P-CSCF 110 to determine the encryption protocol(s), by way of the network policy module 114, that are supported or preferred by the network. In some aspects, network policy module 114 in contained within the P-CSCF 110, but in other aspects, it is a separate network or non-network component.

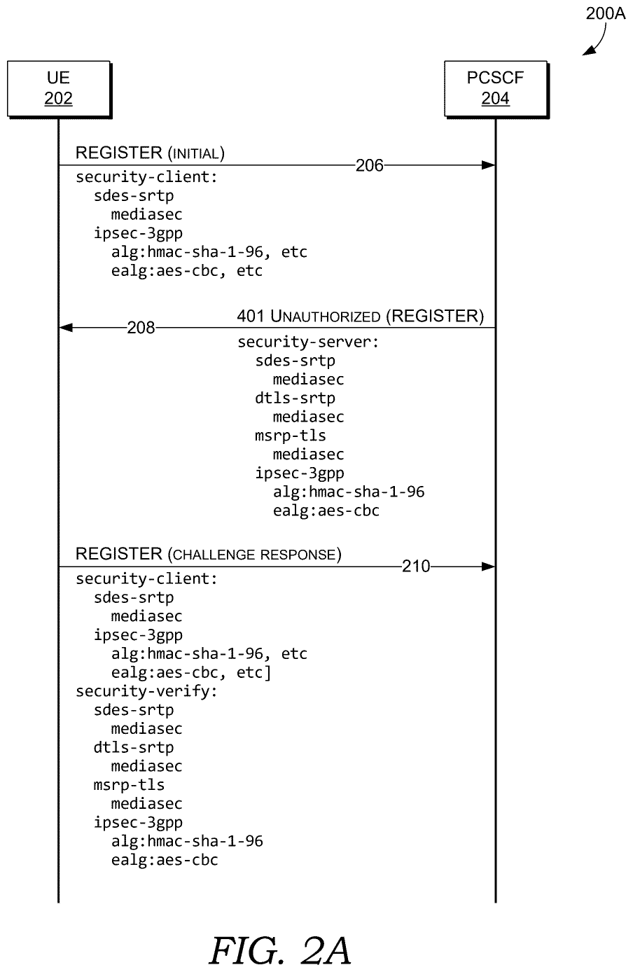

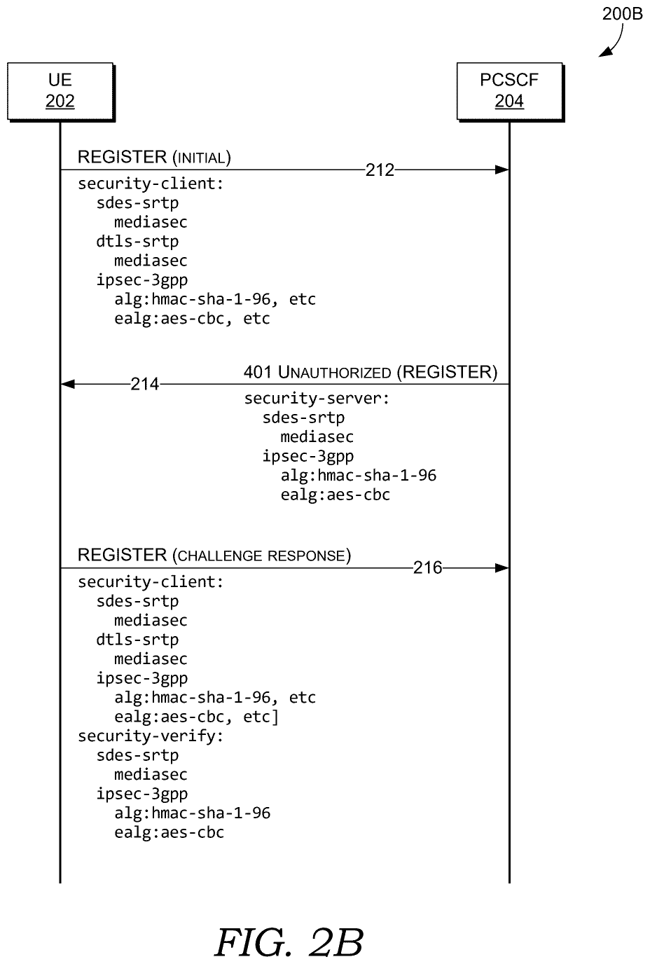

Referring now to FIG. 2A, a communication diagram 200A is illustrated for controlling media plane encryption in a communication network, according to aspects herein. Communication diagram 200A illustrates a scenario prior to implementation of aspects provided herein. User device 202 communicates with P-CSCF 204 for the registration process. A portion of this registration process is illustrated in FIG. 2A. Initially, the user device 202 communicates a register request 206 to P-CSCF 204. This request includes various security-client parameters such as SDES-SRTP, mediasec, and IPSEC-3GPP, along with algorithms like HMAC-SHA-1-96 and AES-CBC. SDES-SRTP and IPSEC-3GPP are encryption parameters that are communicated to the P-CSCF 204. In return, the P-CSCF 204 responds with a 401 Unauthorized message 208, which includes security-server parameters. These parameters mirror those sent by the UE, including the encryption parameters, including SDES-SRTP, mediasec, DTLS-SRTP, MSRP-TLS, and IPSEC-3GPP. User device 202 then sends a REGISTER (challenge response) message 210 back to the P-CSCF 204, reaffirming its supported encryption parameters. This message includes security-client parameters such as SDES-SRTP, mediasec, DTLS-SRTP, and IPSEC-3GPP. FIG. 2A highlights potential issues with policy control, where undesirable encryption methods like MSRP-TLS and DTLS-SRTP may be sent due to the lack of network control over the encryption parameters.

FIG. 2B illustrates a communication diagram 200B for controlling media plane encryption in a communication network, according to aspects herein. FIG. 2B illustrates aspects where the P-CSCF 204 only sends its supported/preferred encryption parameters back to the user device 202. Initially, the user device 202 sends a REGISTER request 212 to the P-CSCF 204, including various security-client parameters. This is similar to the REGISTER request 206 in FIG. 2A. The difference, though, is the response from P-CSCF 204. Here, P-CSCF 204 responds with a 401 Unauthorized message 214, selectively listing only the preferred/supported security-server parameters based on network policy. This includes SDES-SRTP and IPSEC-3GPP, while excluding undesirable methods like DTLS-SRTP and MSRP-TLS. The user device 202 sends a REGISTER (challenge response) 216 message back to the P-CSCF 204, reaffirming its supported encryption parameters.

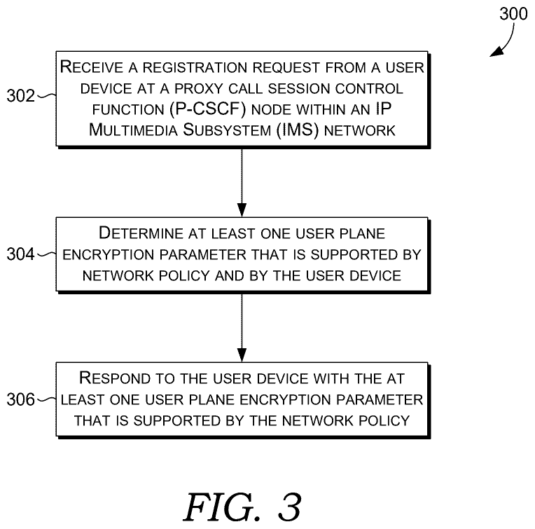

Turning now to FIG. 3, a flow diagram is depicted of an exemplary method 300 for controlling media plane encryption in a communication network, according to aspects herein. At block 302, a registration request is received from a user device at a P-CSCF node within an IMS network. At block 304, at least one user plane encryption parameter that is supported by the network policy and the user device is determined. At block 306, the P-CSCF responds to the user device with the user plane encryption parameter that is supported by the network policy. In some aspects, the at least one user plane encryption parameter comprises SDES-SRPT, DTLS-SRTP, or MSRP-TLS. Others not specifically mentioned herein are contemplated to be within the scope of aspects herein. The P-CSCF responding to the user device with the particular user plane encryption parameters effectively restricts the user device to use only one of the encryption parameters provided by the P-CSCF based on network policy, and further responding to the user device with user plane encryption parameter that is supported by the network policy is done instead of responding to the user device with all of the user plane encryption parameters supported by the user device that were communicated in the registration request. At some point after the exchange of information and registration process, the network policy may be updated resulting in different encryption parameters/protocols being supported and/or preferred by the network. As such, the user plane encryption parameters may be dynamically updated based on changes in network policy or even user device capabilities. In some instances, the user plane encryption parameters may be negotiated between the user device that the P-CSCF of the IMS network, as illustrated by the registration process.

In aspects, the IMS network is configured to dynamically update the user plane encryption parameter(s) based on changes in network policy. Further, the IMS network may monitor changes in network policy and user device capabilities and determine if a current user plane encryption parameter is still supported by an updated network policy. The IMS network then can select a new user plane encryption parameter if the current one is no longer supported by the network policy. This allows the P-CSCF to accurately respond to the user device during the registration process.

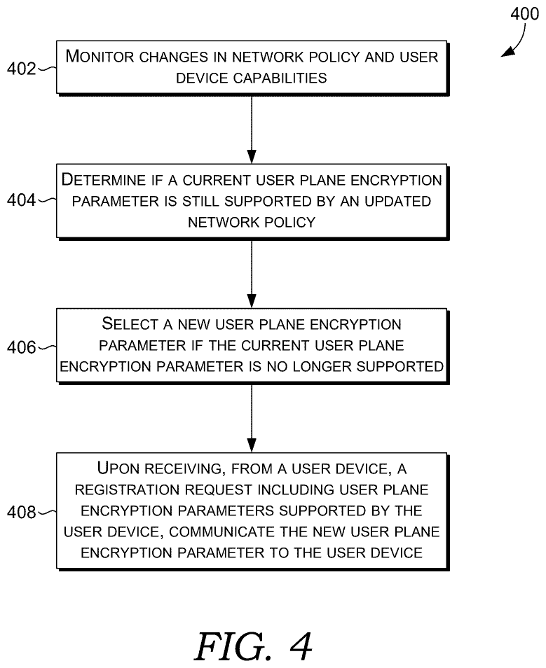

FIG. 4 is a flow diagram of another exemplary method 400 for controlling media plane encryption in a communication network, according to aspects herein. At block 402, changes in network policy are monitored. In aspects, these changes are monitored by the P-CSCF or another network component. At block 404, it is determined if a current user plane encryption parameter is still supported by an updated network policy. At block 406, a new user plane encryption parameter is selected if the current user plane encryption parameter is no longer supported. At block 408, upon receiving, from a user device, a registration request including user plane encryption parameters supported by the user device, the new user plane encryption parameter is communicated to the user device.

Referring to FIG. 5, a representative computer environment is shown and designated generally as computing device 500 that is suitable for use in implementations of the present disclosure. Computing device 500 is but one example of a suitable computing environment and is not intended to suggest any limitation as to the scope of use or functionality of the invention. Neither should computing device 500 be interpreted as having any dependency or requirement relating to any one or combination of components illustrated. In aspects, the computing device 500 is generally defined by its capability to transmit one or more signals to an access point and receive one or more signals from the access point (or some other access point); the computing device 500 may be referred to herein as a user equipment, wireless communication device, or user device. The computing device 500 may take the form of a wireless access device that acts as a more localized and consolidated access point that provides end user wireless devices access to a broader network; examples of wireless access devices include fixed wireless access (FWA) devices and mobile hotspots. The computing device 500 may take the form of a mobile device, used herein to refer to categories of often-portable devices that utilize a wireless connection to a broader network and are typically configured for direct human interaction and personal computing tasks; examples of mobile devices include smartphones, tablets, extended reality (XR) devices (e.g., virtual reality, augmented reality, or mixed reality devices), computers (e.g., laptops and PCs), wearable devices (e.g., smartwatches, fitness tracker), electronic readers (i.e., an e-book reader or digital book reader), portable media player, handheld GPS/location device, digital camera, gaming console, and digital voice recorders. The computing device may take the form of a connected vehicle that integrates advanced communication and computing technologies to interact with other devices and networks, encompassing vehicle to vehicle (V2V) communications, vehicle to infrastructure (V2I) communications, and/or vehicle to everything (V2X) communications, and that utilizes a wireless connection to support telematics, infotainment systems, over the air updates, vehicle health monitoring, and/or enhanced navigation; examples of connected vehicles include automotive, locomotive, airborne, and cargo (e.g., train car, semi-trailer) systems. The computing device 500 may take the form of an Internet of Things (IoT) device, a physical object embedded with sensors, software, or other technologies that enable them to collect, exchange, and act on data using an internet connection, which allows them to perform automated, decision-making or, other content-provision tasks; examples of IoT devices include smart home devices (e.g., smart thermostats, smart lights, power supply/management systems, and smart security systems), connected appliances (e.g., smart refrigerators), health monitoring devices (e.g., blood pressure monitor, glucose monitor), industrial devices (e.g., smart sensors, predictive maintenance systems), and agricultural devices (e.g., soil, environmental, or growth sensors).

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 5, computing device 500 includes bus 502 that directly or indirectly couples the following devices: memory 504, one or more processors 506, one or more presentation components 508, input/output (I/O) ports 510, I/O components 512, and power supply 514. Bus 502 represents what may be one or more busses (such as an address bus, data bus, or combination thereof). Although the devices of FIG. 5 are shown with lines for the sake of clarity, in reality, delineating various components is not so clear, and metaphorically, the lines would more accurately be grey and fuzzy. For example, one may consider a presentation component such as a display device to be one of I/O components 512. Also, processors, such as one or more processors 506, have memory. The present disclosure hereof recognizes that such is the nature of the art, and reiterates that FIG. 5 is merely illustrative of one example of a computing environment that can be used in connection with one or more implementations of the present disclosure. Distinction is not made between such categories as “workstation,” “server,” “laptop,” “handheld device,” etc., as all are contemplated within the scope of FIG. 5 and refer to “computer” or “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 500 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 504 includes computer-storage media in the form of volatile and/or nonvolatile memory. Memory 504 may be removable, nonremovable, or a combination thereof. The memory 504 may take the form of solid-state memory, hard drives, optical-disc drives, etc. Computing device 500 includes one or more processors 506 that read data from various entities such as bus 502, memory 504 or I/O components 512. One or more presentation components 508 presents data indications to a person or other device. The one or more presentation components 508 may comprise one or more of a display device, speaker, printing component, vibrating component, etc. I/O ports 510 allow computing device 500 to be logically coupled to other devices including I/O components 512, some of which may be built in computing device 500. Illustrative I/O components 512 include a microphone, joystick, game pad, satellite dish, scanner, printer, wireless device, etc.

A first radio 520 and a second radio 530 represent radios that facilitate communication with one or more wireless networks using one or more wireless links. In aspects, the first radio 520 utilizes a first transmitter 522 to communicate with a wireless network on a first wireless link and the second radio 530 utilizes the second transmitter 532 to communicate on a second wireless link. Though two radios are shown, it is expressly conceived that a computing device with a single radio (i.e., the first radio 520 or the second radio 530) could facilitate communication over one or more wireless links with one or more wireless networks via both the first transmitter 522 and the second transmitter 532. Illustrative wireless telecommunications technologies include CDMA, GPRS, TDMA, GSM, 802.11, and the like. One or both of the first radio 520 and the second radio 530 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 520 and the second radio 530 may be configured to communicate using the same protocol but in other aspects they may be configured to communicate using different protocols. In some embodiments, including those that both radios or both wireless links are configured for communicating using the same protocol, the first radio 520 and the second radio 530 may be configured to communicate on distinct frequencies or frequency bands (e.g., as part of a carrier aggregation scheme). As can be appreciated, in various embodiments, each of the first radio 520 and the second radio 530 can be configured to support multiple technologies and/or multiple frequencies; for example, the first radio 520 may be configured to communicate with a base station according to a cellular communication protocol (e.g., 4G, 5G, 6G, or the like), and the second radio 530 may be configured to communicate with one or more other computing devices according to a local area communication protocol (e.g., IEEE 802.11 series, Bluetooth, NFC, z-wave, or the like).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for controlling media plane encryption in a communication network, the method comprising:
receiving a registration request from a user device at a proxy call session control function (P-CSCF) node within an IP Multimedia Subsystem (IMS) network, the registration request including user plane encryption parameters supported by the user device;
determining at least one user plane encryption parameter that is supported by network policy and by the user device; and
responding to the user device with the at least one user plane encryption parameter that is supported by the network policy and by the user device.

2. The method of claim 1, wherein responding to the user device with the at least one user plane encryption parameter effectively restricts the user device to use only the at least one user plane encryption parameter for subsequent communications.

3. The method of claim 1, further comprising dynamically updating the at least one user plane encryption parameter based on changes in network policy.

4. The method of claim 1, further comprising negotiating the user plane encryption parameters between the user device and the IMS network during a registration process.

5. The method of claim 1, further comprising ensuring that the user device adheres to the at least one user plane encryption parameter for all communications within the IMS network.

6. The method of claim 1, further comprising selecting a single user plane encryption parameter from the at least one user plane encryption parameter to respond to the user device.

7. The method of claim 1, wherein the responding to the user device with the at least one user plane encryption parameter that is supported by the network policy is performed instead of responding to the user device with all the user plane encryption parameters supported by the user device that were communicated in the registration request.

8. The method of claim 1, wherein the responding to the user device with the at least one user plane encryption parameter that is supported by the network policy enables a network operator to control undesirable user plane encryption.

9. The method of claim 1, wherein the at least one user plane encryption parameter comprises one or more of SDES-SRPT, DTLS-SRTP, or MSRP-TLS.

10. The method of claim 1, wherein the IMS network is further configured to monitor changes in network policy and user device capabilities.

11. The method of claim 10, wherein the IMS network is further configured to determine if a current user plane encryption parameter is still supported by an updated network policy.

12. The method of claim 11, wherein the IMS network is further configured to select a new user plane encryption parameter if the current user plane encryption parameter is no longer supported.

13. A system for controlling media plane encryption in a communication network, the system comprising:
a proxy call session control function (P-CSCF) node within an IP Multimedia Subsystem (IMS) network configured to:
receive a registration request from a user device, the registration request including one or more user plane encryption parameters supported by the user device;
determine at least one user plane encryption parameter that is supported by network policy; and
respond to the user device with the at least one user plane encryption parameter that is supported by the network policy.

14. The system of claim 13, wherein the P-CSCF is further configured to enforce the at least one user plane encryption parameter for all subsequent communications from the user device.

15. The system of claim 13, wherein the responding to the user device with the at least one user plane encryption parameter that is supported by the network policy enables a network operator to control undesirable user plane encryption.

16. The system of claim 13, wherein the P-CSCF is further configured to dynamically update the at least one user plane encryption parameter based on changes in network policy.

17. The system of claim 13, wherein the P-CSCF is further configured to monitor changes in network policy and user device capabilities.

18. The system of claim 17, wherein the P-CSCF is further configured to determine if a current user plane encryption parameter is still supported by an updated network policy.

19. The system of claim 18, wherein the P-CSCF is further configured to select a new user plane encryption parameter if the current user plane encryption parameter is no longer supported.

20. Computer readable media having instructions stored thereon that, when executed by one or more computer processing components, cause the one or more computer processing components to perform a method for dynamically updating media plane encryption parameters in a communication network, the method comprising:
monitoring changes in network policy and user device capabilities;
determining if a current user plane encryption parameter is still supported by an updated network policy;
selecting a new user plane encryption parameter if the current user plane encryption parameter is no longer supported; and
upon receiving, from a user device, a registration request including user plane encryption parameters supported by the user device, communicating the new user plane encryption parameter to the user device.
